(19) United States
(12) Patent Application Publication
(10) Pub. No.: US 2013/0117070 A1
(43) Pub. Date: May 9, 2013

(54) METHOD AND APPARATUS FOR PROVIDING MARKET SIMULATION SERVICE

(71) Applicants: Yu-An Sun, Webster, NY (US); Shi Zhao, Rochester, NY (US); David Russell Vandervort, Walworth, NY (US); William K. Stumbo, Fairport, NY (US)

(72) Inventors: Yu-An Sun, Webster, NY (US); Shi Zhao, Rochester, NY (US); David Russell Vandervort, Walworth, NY (US); William K. Stumbo, Fairport, NY (US)

(73) Assignee: XEROX CORPORATION, Norwalk, CT (US)

(21) Appl. No.: 13/291,613

(22) Filed: Nov. 8, 2011

(51) Int. Cl. G06Q 30/02

(52) U.S. Cl. 705/7.31

(57) ABSTRACT

A method of providing a market simulation service includes: a) receiving a request for predictive information regarding a subsequent competitive bidding process in an existing marketplace, the existing marketplace having been previously used for like competitive bidding processes, the request being received from a user device associated with a prospective participant in the subsequent competitive bidding process, the request including auction parameters and simulation parameters; b) obtaining historical marketplace data from a data storage device, the historical marketplace data associated with the existing marketplace and the plurality of like competitive bidding processes; c) processing the historical marketplace data using a statistical sampling algorithm and a resampling technique based on the auction parameters to determine a distribution function for the like competitive bidding processes; and d) simulating the subsequent competitive bidding process using an evolutionary algorithm based on the simulation parameters and the distribution function to derive the predictive information.

### BACKGROUND

The present exemplary embodiment relates generally to a method of providing a market simulation service. It finds particular application in providing predictive information to a prospective participant in a subsequent competitive bidding process in an existing marketplace after receiving a request for the predictive information from a user device associated with the prospective participant. The request includes auction parameters and simulation parameters. Historical marketplace data associated with the existing marketplace and like competitive bidding processes is obtained from a data storage device. The historical marketplace data is processed using a statistical sampling algorithm and a resampling technique based on the auction parameters to determine a distribution function for the like competitive bidding processes. The subsequent competitive bidding process is simulated using an evolutionary algorithm based on the simulation parameters and the distribution function to derive the predictive information. It is to be appreciated that the exemplary market simulation service described herein can be modified to use a variety of statistical sampling algorithms, resampling techniques, and evolutionary algorithms in any suitable combination. For example, the resampling technique may comprise a bootstrapping technique and the evolutionary algorithm may comprise a genetic algorithm.

In an auction marketplace, both providers and buyers have a need for decision support software to help them identify optimal strategies. For example, providers want to develop bidding strategies to help maximize their chance of success and buyers want to know when to close the auction. The auction marketplace may be a “help wanted”-type of marketplace for contracting labor, a “goods/services wanted”-type of marketplace for contracting goods, services, or a combination thereof, a “sales”-type of marketplace for selling goods, a “services”-type of marketplace for offering services, or any combination thereof.

Auction sites, such as eBay.com, priceline.com, oDesk.com, eLance.com, and guru.com, are currently accessible via the Internet. Some online auctions provide historic bids for bidders' reference. However, current auction sites do not provide bidding assistance services to participants in the auction, such as how much to bid or when to accept a bid and close the auction. Based on the foregoing, there is a need for bidding assistance services that provide strategies for participants in online auctions and other types of auction marketplaces. Recommended strategies and other bidding assistance services go beyond merely providing historic records for reference by the participants.

### INCORPORATION BY REFERENCE

The following documents are fully incorporated herein by reference: 1) U.S. Pat. App. Publication No. 2010/0145842 to Rao, Ser. No. 12/331,677, filed Dec. 10, 2008; 2) U.S. Pat. App. Publication No. 2010/0145863 to Rao, Ser. No. 12/331,740, filed Dec. 10, 2008; 3) U.S. Pat. App. Publication No. 2003/0163410 to Byde et al., Ser. No. 10/365,367, filed Feb. 12, 2003; and 4) Tapping into the Human Cloud—A Blueprint for Building Your Startup in the Cloud, Elance, Inc., 2011 (8 pages).

### BRIEF DESCRIPTION

In one aspect, a method of providing a market simulation service is provided. In one embodiment, the method includes: a) receiving a request for predictive information regarding a subsequent competitive bidding process in an existing marketplace, the existing marketplace having been previously used for a plurality of like competitive bidding processes, the request being received from a user device via a communication network at a simulation server, the user device being associated with a prospective participant in the subsequent competitive bidding process, the simulation server being associated with a market simulation service, the prospective participant being associated with the market simulation service, wherein the request includes auction parameters and simulation parameters, the auction parameters identifying the subsequent competitive bidding process and defining certain descriptive characteristics associated with the subsequent competitive bidding process, the simulation parameters identifying the predictive information desired by the prospective participant and defining certain simulation settings for deriving the predictive information; b) obtaining historical marketplace data from a data storage device, the historical marketplace data associated with the existing marketplace and the plurality of like competitive bidding processes; c) processing the historical marketplace data using a statistical sampling algorithm and a resampling technique based at least in part on the auction parameters to determine a distribution function for the like competitive bidding processes; and d) simulating the subsequent competitive bidding process using an evolutionary algorithm based at least in part on the simulation parameters and the distribution function to derive the predictive information desired by the prospective participant.

In another aspect, an apparatus for providing a market simulation service is provided. In one embodiment, the apparatus includes: a participant communication module for receiving a request for predictive information regarding a subsequent competitive bidding process in an existing marketplace, the existing marketplace having been previously used for a plurality of like competitive bidding processes, the request being received from a user device via a communication network, the user device being associated with a prospective participant in the subsequent competitive bidding process, the prospective participant being associated with the market simulation service, wherein the request includes auction parameters and simulation parameters, the auction parameters identifying the subsequent competitive bidding process and defining certain descriptive characteristics associated with the subsequent competitive bidding process, the simulation parameters identifying the predictive information desired by the prospective participant and defining certain simulation settings for deriving the predictive information; a historical data communication module for obtaining historical marketplace data from a data storage device, the historical marketplace data associated with the existing marketplace and the plurality of like competitive bidding processes; a statistics processing module in operative communication with participant communication module and historical data communication module for processing the historical marketplace data using a statistical sampling algorithm and a resampling technique based at least in part on the auction parameters to determine a distribution function for the like competitive bidding processes; and a simulation processing module in operative communication with the participant communication module and statistics processing module for simulating the subsequent competitive bidding process using an evolutionary algorithm based at least in part on the simulation parameters and the distribution function to derive the predictive information desired by the prospective participant.

In yet another aspect, a non-transitory computer-readable medium storing program instructions that, when executed by a computer, cause a corresponding computer-controlled device to perform a method of providing a market simulation service. In one embodiment, the method includes: a) obtaining historical marketplace data from a data storage device in response to receiving a request for predictive information regarding a subsequent competitive bidding process in an existing marketplace, the existing marketplace having been previously used for a plurality of like competitive bidding processes, the historical marketplace data associated with the existing marketplace and the plurality of like competitive bidding processes, the request being received from a user device via a communication network, the user device being associated with a prospective participant in the subsequent competitive bidding process, the prospective participant being associated with a market simulation service, wherein the request includes auction parameters and simulation parameters, the auction parameters identifying the subsequent competitive bidding process and defining certain descriptive characteristics associated with the subsequent competitive bidding process, the simulation parameters identifying the predictive information desired by the prospective participant and defining certain simulation settings for deriving the predictive information; b) processing the historical marketplace data using a statistical sampling algorithm and a resampling technique based at least in part on the auction parameters to determine a distribution function for the like competitive bidding processes; and c) simulating the subsequent competitive bidding process using an evolutionary algorithm based at least in part on the simulation parameters and the distribution function to derive the predictive information desired by the prospective participant.

### BRIEF DESCRIPTION OF THE DRAWINGS

FIG. 1 is a block diagram of an exemplary embodiment of an analytics architecture for providing an exemplary market simulation service;

FIG. 2 is function diagram of an exemplary embodiment of a network architecture for providing an exemplary market auction service;

FIG. 3 is a functional diagram of an exemplary embodiment of a process flow for providing an exemplary market simulation service;

FIG. 4 is a functional diagram of an exemplary embodiment of an optimization engine with a genetic algorithm for providing an exemplary market simulation service;

FIG. 5 is an exemplary display screen for a web portal to an exemplary embodiment of an exemplary market simulation service;

FIG. 6 is an exemplary histogram showing a distribution of bidding coefficients for 80 providers in conjunction with an exemplary auction simulation processed by an exemplary market simulation service;

FIG. 7 is an exemplary histogram showing a distribution of bidding time for 80 providers in conjunction with an exemplary auction simulation processed by an exemplary market simulation service;

FIG. 8 is a flowchart of an exemplary embodiment of a process for providing a market simulation service;

FIG. 9 is a block diagram of an exemplary system with an exemplary embodiment of a simulation server for providing an exemplary market simulation service; and

FIG. 10 is a flowchart of another exemplary embodiment of a process for providing an exemplary market simulation service that is performed by a computer-controlled device executing program instructions stored on a non-transitory computer-readable medium.

### DETAILED DESCRIPTION

This disclosure provides various embodiments of a method for simulating an auction based on historical bidding data for similar auctions and user population data for participants in the auction. In one embodiment, the simulation predicts a winning bid for the auction and provides a corresponding strategy for a buyer soliciting bids for desired services or goods via the auction. In another embodiment, the simulation provides a bid strategy for a provider participating in the auction and competing for the desired services or goods. In yet another embodiment, the simulation predicts the winning bid and provides a corresponding strategy for a seller offering services or goods for sale via the auction. In still another embodiment, the simulation provides a bid strategy for a participant in the auction desiring to purchase the offered services or goods.

The various embodiments of the method for simulating the auction combine bootstrapping methods to accumulate and process the historical bidding data and genetic algorithms to perform bidding simulations to provide a decision support tool that presents strategies to auction participants. The simulations are tested for best fit in order to predict the winning bid or price. The predicted winning bid can be used to assist a bidder in deciding upon a bidding approach to optimize their likelihood of winning the bid.

Genetic algorithms are suited to complex problem spaces, such as auctions, because simulation results from genetic algorithms are near optimal. The method can provide all participants in an auction with an optimal bidding strategy. Widespread use is still beneficial, even if all participants are getting the same bidding strategy. For example, if multiple poker players used an optimal strategy, it would not reduce the benefit of the optimal strategy to any one player.

The bidding strategy provided to a participant in the auction is based on the distribution of bids in the previous auctions for similar goods or services. The various embodiments of the method for simulating the auction provide a decision support tool based on statistical sampling methods and genetic algorithms. The overall system architecture includes a web portal, a set of marketplace application program interfaces (APIs), and an optimization engine in a kernel layer. For example, the optimization engine may include genetic algorithms. The simulation takes input from both users participating in the auction and historical marketplace data from previous auctions. After applying bootstrapping techniques to accumulate and process this data, a distribution density function is computed and used as input for simulations conducted within the optimization engine to identify optimal auction strategies. Specific strategies are tailored to the role of the participant. For example, strategies may be provided to a buyer soliciting bids for desired services or goods, one or more providers submitting competitive bids for the desired services or goods, or to any combination of participants in a subsequent competitive bidding process.

Genetic algorithms may be used within the optimization engine because they provide an effective search technique for a complex, unconstrained problem space, such as an auction. The combination of bootstrapping methods with the optimization engine provides a better distribution from which to draw simulations. In a genetic algorithm simulation for auction settings, a very large number of random data points are drawn from the distribution function; thus, the accuracy of the population distribution contributes to the accuracy of the simulation results. The simulation results include predicted bidding behaviors and strategies that can be adopted by participants in the auction (e.g., buyers or providers) as optimal strategies.

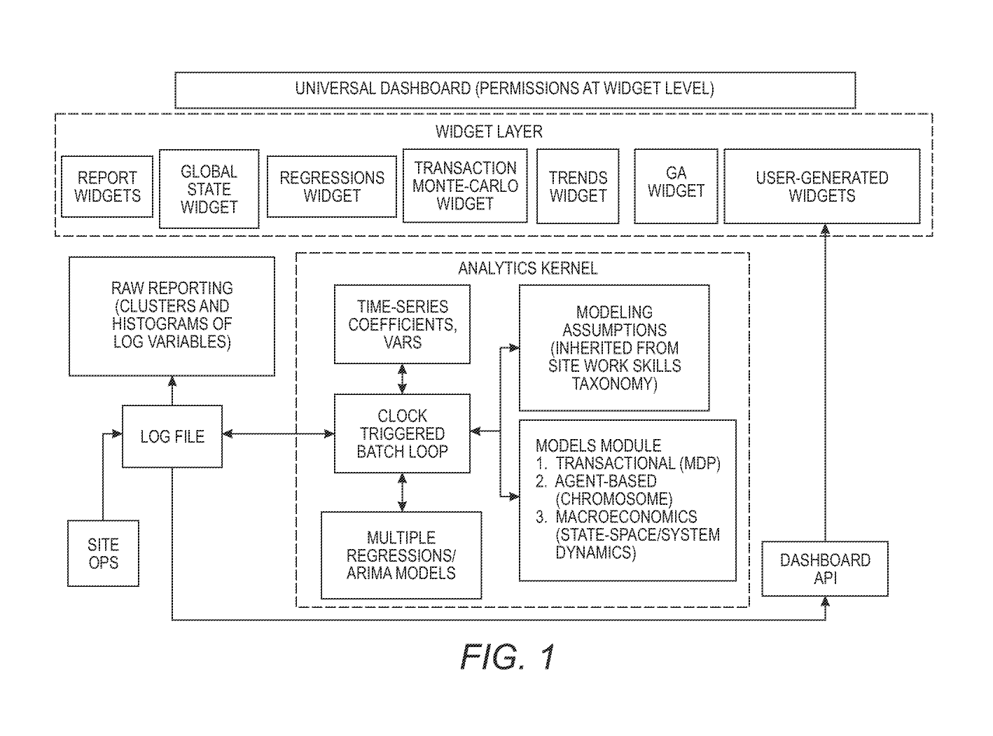

With reference to FIG. 1, an exemplary embodiment of an analytic architecture for an auction platform includes a universal dashboard, a widgets layer, and an analytics kernel. For example, the auction platform may be used to implement an on-demand labor auction. Auctions represent complex interactions of providers and bidders. For instance, in the on-demand labor marketplace, there are providers bidding for jobs and buyers offering projects to be bid on. Providers can create a subtask, breaking a project into smaller tasks, to be bid on by other providers and forming recursive auctions. For additional information on the concept of recursive auctions, see U.S. Pat, App. Publication No. 2010/0145842 to Rao, Ser. No. 12/331,677, filed Dec. 10, 2008 and U.S. Pat. App. Publication No. 2010/0145863 to Rao, Ser. No. 12/331,740, filed Dec. 10, 2008, the contents of which are fully incorporated herein by reference.

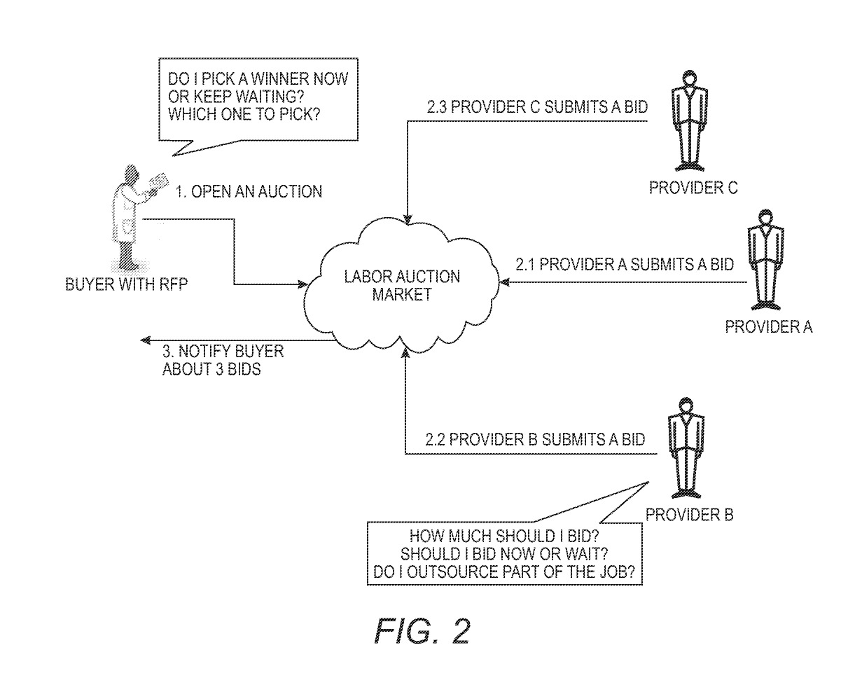

Having tools to aid in decision making helps participants in the auction to succeed in the market. FIG. 2 illustrates the need for both buyers and providers to have decision support tools in this environment. Additionally, the table below highlights the difference between existing solutions and implementing the simulation service described herein.

| | | Without | With |
|---|---|---|---|
| | Questions to answer | Simulation | Simulation |
| Buyers | When to end the auction | Historical | Suggested |
| | Which team to pick as winner | data as | optimal |
| Providers | How much to bid | indication | strategy |
| | How many people to be in a team | | |
| | To bid at what point of an auction | | |
| | life cycle | | |
| | How many levels to outsource a | | |
| | bid | | |

With reference again to FIG. 1, the overall design of the analytics architecture includes three major layers: i) an analytics kernel, ii) a widgets layer, and iii) a universal dashboard. The analytics architecture is designed to take historical data from the real marketplace, represented as log files and perform further analysis based on the raw data.

Genetic algorithms are based on Darwinian natural evolution theory. Under this theory, the evolution of species is mainly controlled by genes which are inherited from parents. Instead of reproducing the same genes from one single source, the genes are a mix of those of both parents, with possible random changes, known as mutations.

Adopting the biological model of evolution, solutions in genetic algorithms are referred to as chromosomes. Similar to the notion of the survival of the fittest in the Darwinian natural evolution theory, a fitness function determines survival of solutions or chromosomes in genetic algorithms. This could be an objective function or a subjective function defined by human decisions. Genetic algorithms are iterative algorithms, and possible solutions are iteratively selected or rejected based on their fitness. Beginning with a first set of possible solutions, pairs of accepted solutions generate solutions for the next iteration using crossover and mutation techniques. This process is repeated until suitable solutions or chromosomes are created or until a predetermined time expires.

Selection of solutions is crucial in the genetic algorithm because it decides how to proceed with further iterations to obtain more solutions from select prior solutions. There are several different ways of performing selection. For example, roulette wheel selection, tournament selection, or truncation selection. Chromosomes with higher fitness scores will have a higher percentage in the roulette wheel selection. In the tournament selection, the algorithm will randomly pick any two (or more) chromosomes, compare fitness scores, and keep the best one. The truncation method is the most trivial selection method. Truncation selection doubles the better half population and truncates the other half.

The crossover function mimics the biological reproduction process. It combines bits from parents identified by the selection function. There are two methods for crossover: one-point crossover and two-point crossover. For a one-point crossover, the algorithm first randomly picks a point in the bit strings. All bits before that point are from one parent and all bits after that point are from the other parent. Two-point crossover works similarly, using two points to divide each parent into three segments and create one or more crossover combination.

Mutation provides the variation needed in the genetic algorithm to prevent it from being limited by its first (randomly chosen) set of solutions. One bit in the chromosome bit string is randomly flipped. Mutation can also be viewed as a random walk away from the original chromosome. Because mutation causes variation, global optimization can be achieved. The mutation rate affects the speed of population convergence.

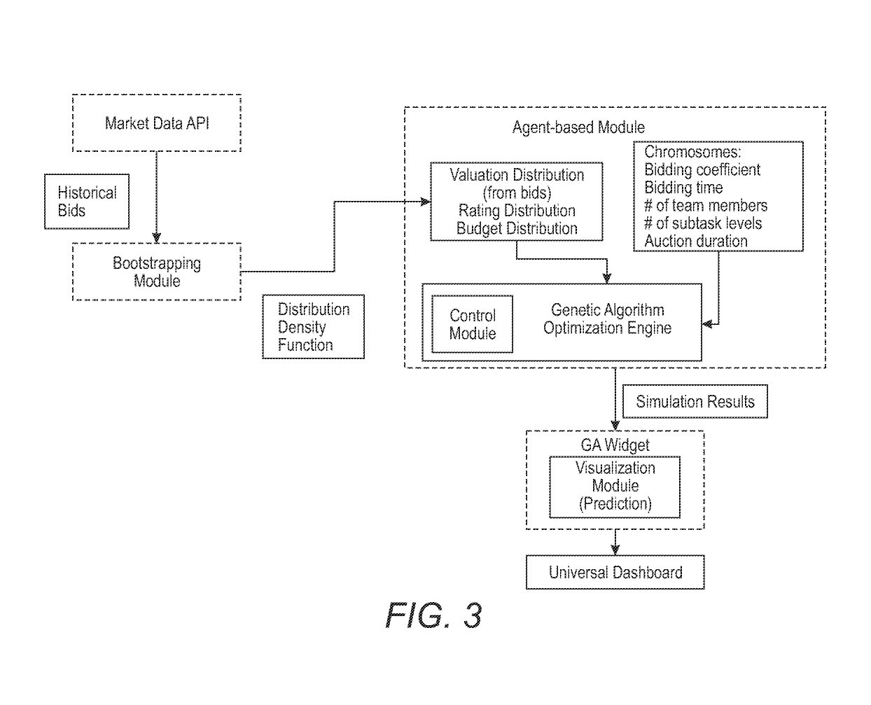

With reference to FIG. 3, an exemplary embodiment of a process flow through the analytics architecture for an auction simulation uses an agent-based module and a genetic algorithm widget. The agent-based module is part of the analytics kernel. The genetic algorithm widget is in the widget layer. The genetic algorithm widget passes simulation results back to the universal dashboard. The agent-based module first takes a log file from the auction site and generates valuation distributions, rating distributions, and budget distributions from historical auction data stored in the log file. The chromosome encoding is generated from user input or fixed values. The chromosome encoding represents the auction conditions that need to be optimized.

Five different exemplary auction conditions or variables (i.e., chromosomes) are identified in FIG. 3, including: i) bidding coefficient, ii) bidding time, iii) number of team members, iv) number of subtask levels, and iv) auction duration. The bidding coefficient represents the relationship between the bid and the valuation (how much the provider really values this job). A bidding coefficient less than one represents underbidding and a bidding coefficient more than one represents overbidding. The distribution file and chromosome file are the inputs to the genetic algorithm optimization engine. Once the simulation results are generated, the genetic algorithm widget can visualize the results by plotting a time-series graph and show predicted results over time for the five variables. The number of variables to be optimized can vary depending on the exact problem being investigated.

Bootstrapping is a model statistical approach using Monte Carlo sampling to draw statistical inference, which falls into a broader class of resampling methods. Bootstrapping may be useful for the situations where the theoretical distribution is unknown or it is difficult to derive analytically. Bootstrapping may also be useful when the sample size of observations is small and not sufficient to apply regular statistical inference. The bootstrapping algorithm provides better results over a traditional statistical approach. In most real practices, as well as in the auction marketplace, where both the above situations exists, the bootstrapping method is very useful.

Historical bid data is the input for the bootstrapping module and the output is a distribution function of bids. The bootstrapping algorithm adopted for solving the auction marketplace problem may include denoting the historical data of N bids by S={x1, x2, . . . xN}, where S is an observed sample and will be treated as the population to which Monte Carlo sampling is applied. The bootstrapping module may follow the following steps: 1) Given S, identify the type of bidding distribution F from, for example, i) fitting a parametric distribution using a maximum likelihood function to choose, for example, a normal distribution, a uniform distribution, or an exponential distribution as the underlying distribution of bids or ii) fitting a nonparametric distribution which is simply an empirical distribution of bids. This step provides a rough idea about the shape of the distribution; 2) Resample bids from S for K times using simple random sampling with replacement (SRSWR) (N,n) to get K bidding samples (i.e., S1, S2, . . . Sk). This is the Monte Carlo sampling step. 3) Based on each Si, the estimated distribution is denoted as Fi to estimate the distribution function. Thus we will provide K estimates; and 4) Combine these K distribution functions: F1, F2, . . . Fk with equal weight 1/K into a distribution function. The distribution function is used as the estimated distribution of F which is the output of the bootstrapping module.

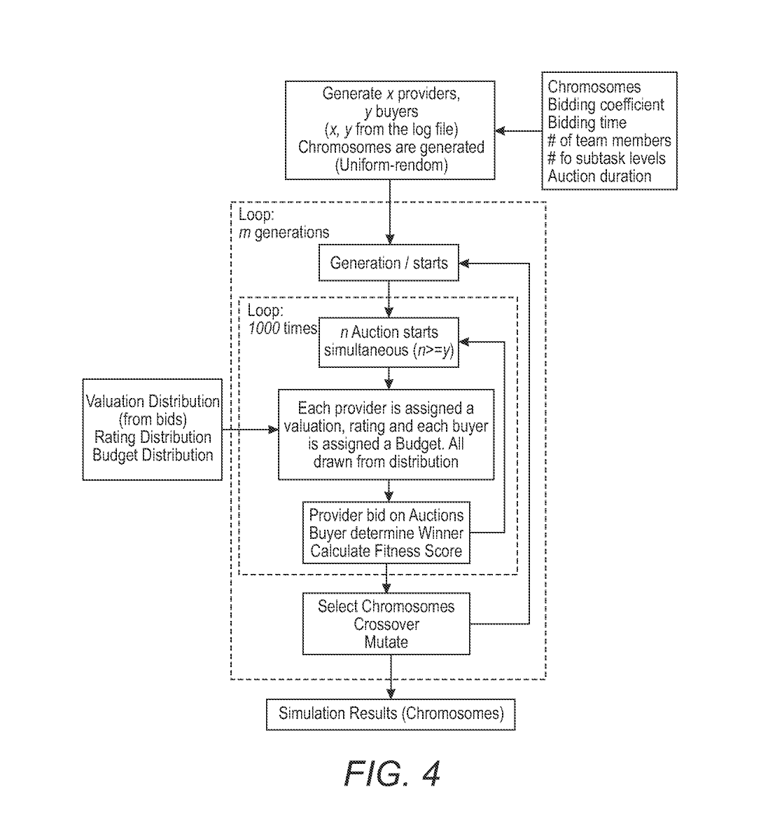

With reference to FIG. 4, an exemplary embodiment of an algorithm inside the genetic algorithm optimization engine is provided. The m and n variables are set to run the optimization engine. The m variable defines the number of generations. The n variable defines the number of auctions. Another variable is set to define the number of auction rounds per generation. Winning an auction depends on the actions of all of the providers (e.g., bidders) participating in the auction instead of just one. Therefore, multiple auctions per generation are run to get a good expected payoff as a good fitness score for providers. The number of auctions and the number of generations may be determined by a trial- and error method. In one embodiment, a genetic algorithm control module is provided as part of the genetic algorithm optimization engine. The control module uses statistical measures as an indicator of the population convergence. The control module monitors the standard deviation of the population and increases the number of auctions and the number of generations until the standard deviation of the population is lower than 0.05.

A simple prototype version of a market simulation service was implemented with a web portal. In the simple implementation, no log file was provided. Instead, the prototype tool drew valuation and budget values from a uniform distribution. The chromosome encoding in the prototype included the bidding coefficient and bidding time. The number of providers, x, and the number of buyers, y, were inputs from the web portal instead of being generated from the log file. The following tables summarize the features demonstrated by the prototype version and features available in other embodiments of method of providing an auction simulation.

| | | Alternate |
|---|---|---|
| | Prototype Feature | Embodiment Feature |
| genetic algorithm | As histogram figure | Should include a summary of |
| visualization widget | on web portal | suggested bidding strategies |
| genetic algorithm | With 3 variables | Number of variables should |
| optimization engine | | be customizable |
| genetic algorithm | Ask user input for | Should include automated |
| convergence | number of | control module use standard |
| control module | generation and | deviation as measure |
| | number of auctions | |
| | per generation | |
| Import market data | Integrated with | Integrated with market data |
| | market data API | API |
| | (already | |
| | implemented | |
| | the full version | |

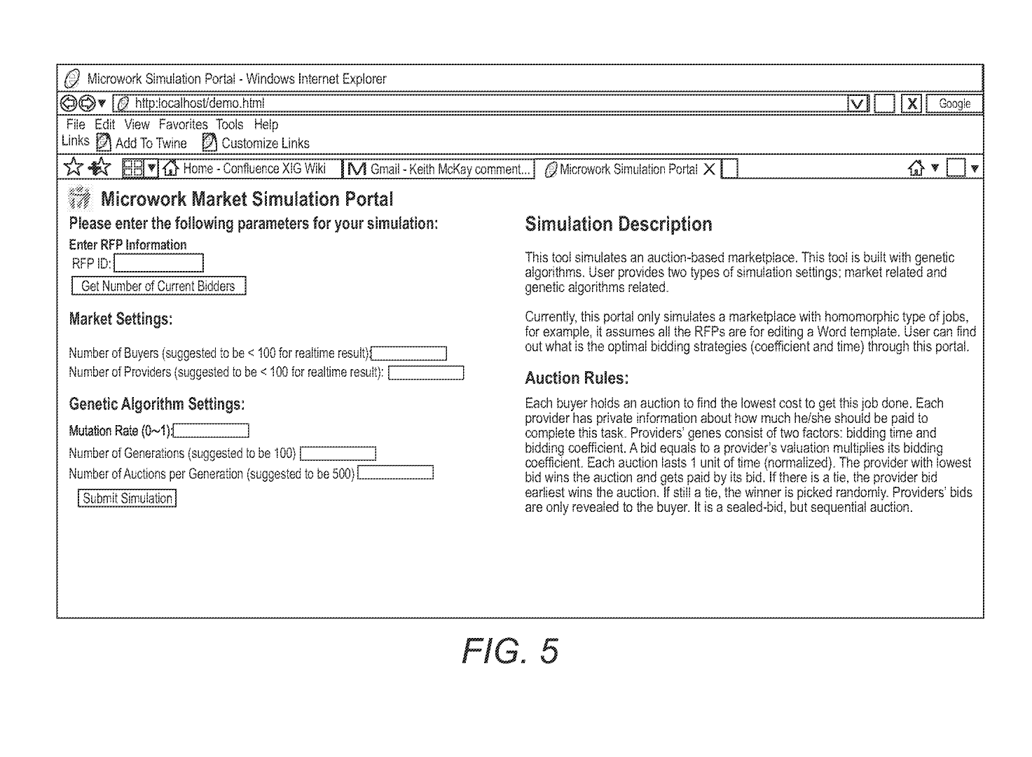

With reference to FIG. 5, a screen shot of an exemplary embodiment of the web portal is provided. In this embodiment, the web portal is running a cgi script on an Apache web server. In the web portal, the user can input the number of providers, number of buyers, number of generations, and the mutation rate.

The tool simulates an auction-based marketplace. The tool is built with a genetic algorithm. The user provides two types of simulation settings: market related and genetic algorithm related.

In this example, the market parameters entered via the web portal include request for proposal (RFP) identification, number of buyers, and number of providers. As used herein, an RFP includes any type of solicitation of a bid, including a request for quotation (RFQ), an invitation for bid (IFB), an invitation to bid (ITB), a “for sale” listing, or a “want ad” listing. The web portal can also be used to enter simulation parameters, such as mutation rate, number of generations, and number of auctions per generation.

For example, the web portal may simulate a marketplace with homomorphic types of jobs. For example, it assumes all RFPs are for editing a Word template. The user can find out the optimal bidding strategies (bidding coefficient and auction duration (i.e., bidding time)) using the web portal.

The auction rules establish that each buyer holds an auction to find the lowest cost to get a job done. Each provider has private information about how much he/she should be paid to complete the task. Providers' genes include two factors: bidding time and bidding coefficient. A bid divided by a provider's valuation is the provider's bidding coefficient. Each auction lasts one unit of time (normalized). The provider with the lowest bid wins the auction and gets paid based on its bid. If there is a tie, the provider that bid earliest wins the auction. If there is still a tie, the winner is picked randomly. Providers' bids are only revealed to the buyer. It is a sealed-bid, but sequential auction.

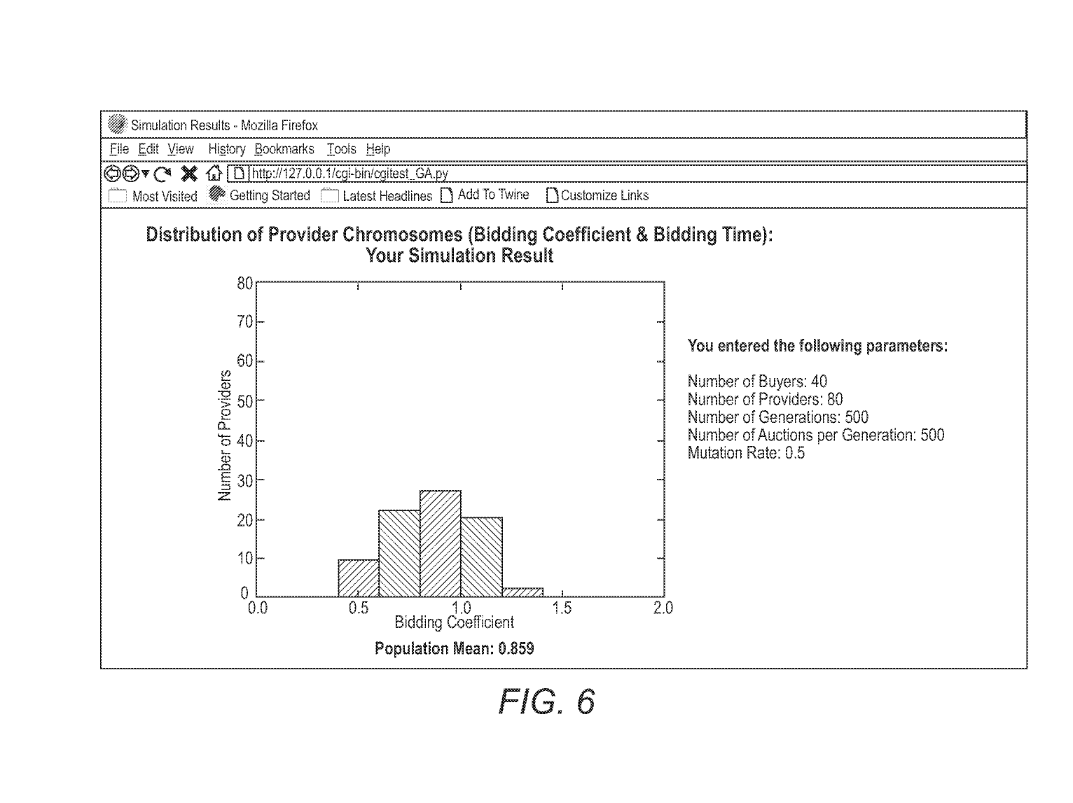

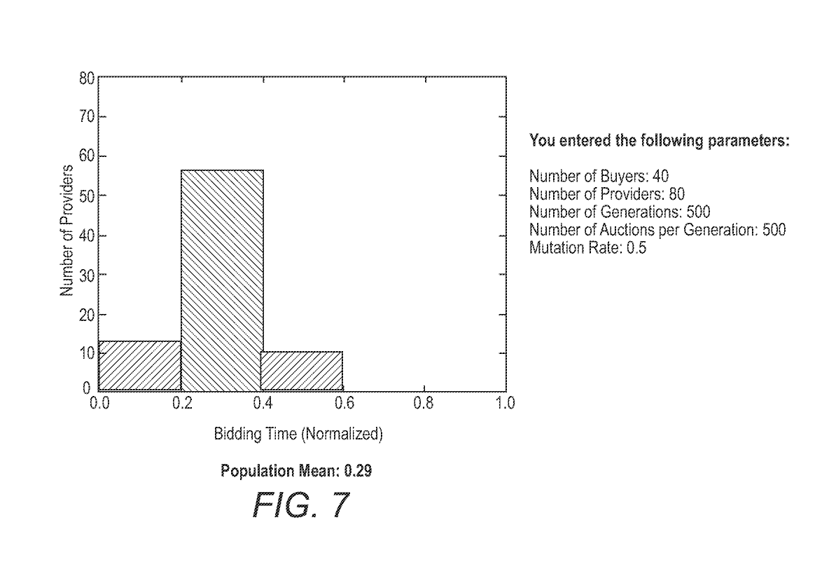

With reference to FIGS. 6 and 7, screen shots of exemplary simulation results are shown for simulations implementing bidding coefficient and bidding time variables. From the histograms, one can see the population is converged and the mean value is the optimized result.

In summary, various embodiments of a process for providing a market simulation service disclosed herein use a genetic algorithm-based optimization engine in a decision support tool for an auction environment. Previous use of raw market data does not have prediction and decision support functionalities. The usage of a genetic algorithm allows exploration of “What if” scenarios using the historical data.

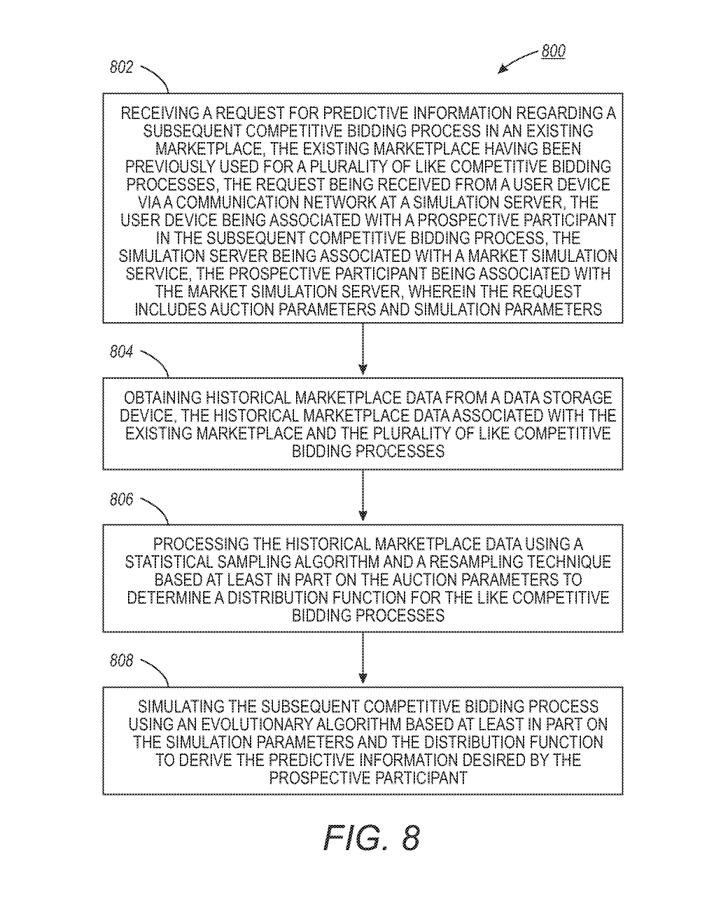

With reference to FIG. 8, an exemplary embodiment of a process 800 for providing a market simulation service begins at 802 where a request for predictive information regarding a subsequent competitive bidding process in an existing marketplace is received. The existing marketplace having been previously used for a plurality of like competitive bidding processes. The request being received from a user device via a communication network at a simulation server. The user device being associated with a prospective participant in the subsequent competitive bidding process. The simulation server being associated with a market simulation service. The prospective participant being associated with the market simulation service. The request including auction parameters and simulation parameters. The auction parameters identifying the subsequent competitive bidding process and defining certain descriptive characteristics associated with the subsequent competitive bidding process. The simulation parameters identifying the predictive information desired by the prospective participant and defining certain simulation settings for deriving the predictive information.

At 804, historical marketplace data is obtained from a data storage device, the historical marketplace data associated with the existing marketplace and the plurality of like competitive bidding processes. Next, the historical marketplace data is processed using a statistical sampling algorithm and a resampling technique based at least in part on the auction parameters to determine a distribution function for the like competitive bidding processes (806). At 808, the subsequent competitive bidding process is simulated using an evolutionary algorithm based at least in part on the simulation parameters and the distribution function to derive the predictive information desired by the prospective participant.

As used herein, a statistical sampling algorithm includes any suitable sampling algorithm capable of processing the historical marketplace data to produce suitable statistical parameters for the like competitive bidding processes, including random sampling, systematic sampling, stratified sampling, probability-proportional-to-size sampling, cluster sampling, quota sampling, convenience sampling, panel sampling, and empirical sampling. As used herein, a resampling technique includes any suitable resampling technique capable of operating in conjunction with the statistical sampling algorithm to determine a suitable distribution function for the like competitive bidding processes, including jackknifing techniques, bootstrapping techniques, permutation testing techniques, and cross-validation techniques.

As used herein, a bootstrapping technique is a computer-based method for assigning measures of accuracy to sample estimates. Bootstrapping is the practice of estimating properties of an estimator (such as its variance) by measuring those properties when sampling from an approximating distribution. One standard choice for an approximating distribution is the empirical distribution of the observed data. In the case where a set of observations can be assumed to be from an independent and identically distributed population, this can be implemented by constructing a number of resamples of the observed dataset (and of equal size to the observed dataset), each of which is obtained by random sampling with replacement from the original dataset.

As used herein, a Monte Carlo algorithm is a randomized algorithm whose running time is deterministic. Normally, the answer returned by a deterministic algorithm is expected to be correct. However, the output from a Monte Carlo algorithm may return a probability of being correct or incorrect. Monte Carlo algorithms are generally classified as either false-biased or true-biased. A false-biased Monte Carlo algorithm is correct when it returns false. A true-biased Monte Carlo algorithm behaves likewise, mutatis mutandis. Other Monte Carlo algorithms may have no bias. These are said to have two-sided errors. The output (either true or false) from Monte Carlo algorithms with two-sided errors will be incorrect or correct with some bounded probability.

As used herein, an evolutionary algorithm may include a subset of evolutionary computations and a generic population-based meta-heuristic optimization algorithm. An evolutionary algorithm uses some mechanisms inspired by biological evolution: reproduction, mutation, recombination, and selection. Candidate solutions to the optimization problem play the role of individuals in a population, and the fitness function determines the environment within which the solutions “live.” Evolution of the population takes place after the repeated application of the above operators.

As used herein, a genetic algorithm includes a search heuristic that can mimic the process of natural evolution. This heuristic is routinely used to generate useful solutions to optimization and search problems. Genetic algorithms belong to a larger class of evolutionary algorithms, which generate solutions to optimization problems using techniques inspired by natural evolution, such as inheritance, mutation, selection, and crossover.

In another embodiment, the process 800 also includes making the derived predictive information available to the user device at the simulation server via the communication network. In yet another embodiment, the process 800 also includes sending the derived predictive information from the simulation server to the user device via the communication network.

In still another embodiment of the process 800, the subsequent competitive bidding process is provided via an auction server associated with a market auction service. In a further embodiment of the process 800, the auction server is in operative communication with the data storage device to provide historical marketplace data to the data storage device for use in conjunction with the market simulation service. In another further embodiment of the process 800, the existing marketplace comprises the market auction service and market simulation service.

In still yet another embodiment of the process 800, the resampling technique comprises a bootstrapping technique. In a further embodiment of the process 800, the bootstrapping technique comprises a random sampling with replacement algorithm. In another further embodiment of the process 800, the bootstrapping technique comprises a Monte Carlo algorithm.

In another embodiment of the process 800, the evolutionary algorithm comprises a reproduction mechanism, a mutation mechanism, a recombination mechanism, and a selection mechanism. In yet another embodiment of the process 800, the evolutionary algorithm comprises a genetic algorithm.

In still another embodiment of the process 800, the subsequent competitive bidding process comprises an RFP with a bid to provide a specific product or service released by a prospective buyer of the specific product or service so that prospective providers can submit competitive bids in conjunction with the competitive bidding process. In a further embodiment of the process 800, the prospective participant in the subsequent competitive bidding process comprises the prospective buyer of the specific product or service that released the RFP. In an even further embodiment, the predictive information comprises at least one of a time parameter value representing when to end the subsequent competitive bidding process and a bid parameter value representing when to end the subsequent competitive bidding process. In another further embodiment of the process 800, the prospective participant in the subsequent competitive bidding process comprises a first prospective provider that is considering submitting a competitive bid for providing the specific product or service in conjunction with the competitive bidding process. In an even further embodiment, the predictive information comprises at least one of a bid parameter value representing how much to bid for providing the specific product or service, a provider team parameter value representing how to structure a team of providers to bid on providing the specific product or service, a time parameter value representing when to submit the competitive bid during the subsequent competitive bidding process, and an outsource parameter value representing how many levels to outsource in conjunction with bidding on providing the specific product or service.

In still yet another embodiment of the process 800, the subsequent competitive bidding process comprises an offer for sale of a specific product or service released by a prospective provider of the specific product or service so that prospective buyers can submit competitive bids in conjunction with the competitive bidding process. In a further embodiment of the process 800, the prospective participant in the subsequent competitive bidding process comprises the prospective provider that offered the specific product or service for sale. In an even further embodiment, the predictive information comprises at least one of a time parameter value representing when to end the subsequent competitive bidding process and a bid parameter value representing when to end the subsequent competitive bidding process. In another further embodiment of the process 800, the prospective participant in the subsequent competitive bidding process comprises a first prospective buyer that is considering submitting a competitive bid to buy the specific product or service in conjunction with the competitive bidding process. In an even further embodiment, the predictive information comprises at least one of a bid parameter value representing how much to bid for buying the specific product or service and a time parameter value representing when to submit the competitive bid during the subsequent competitive bidding process.

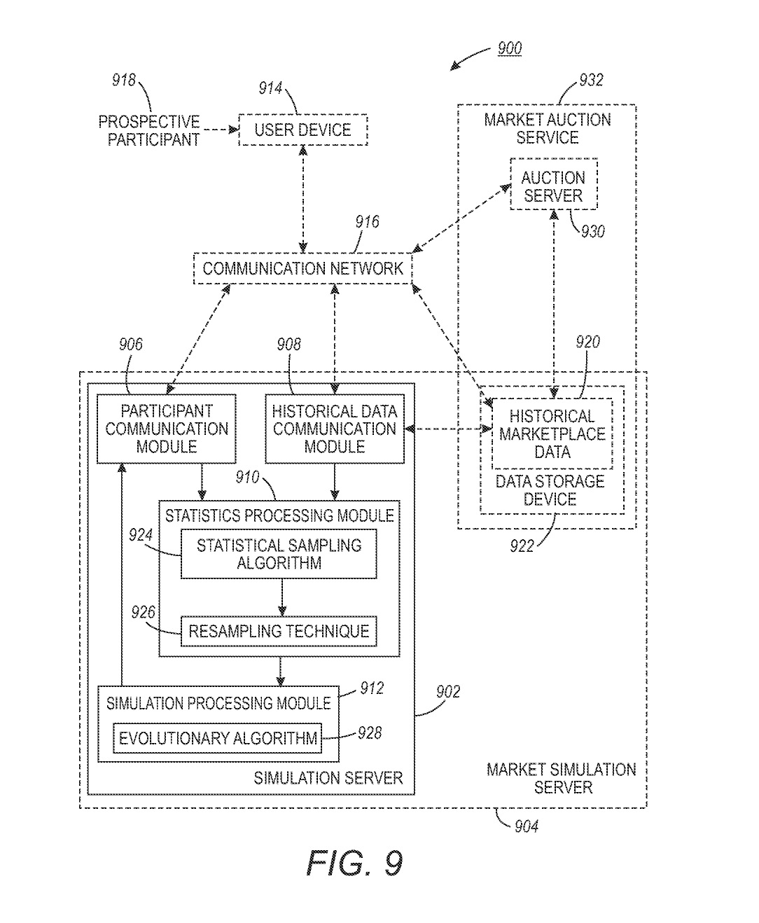

With reference to FIG. 9, an exemplary system 900 includes an exemplary embodiment of a simulation server 902 for providing a market simulation service 904. In this embodiment, the simulation server 902 includes a participant communication module 906, a historical data communication module 908, a statistics processing module 910, and a simulation processing module 912.

The participant communication module 906 is configured to receive a request for predictive information regarding a subsequent competitive bidding process in an existing marketplace. The existing marketplace having been previously used for a plurality of like competitive bidding processes. The request being received from a user device 914 via a communication network 916. The user device 914 being associated with a prospective participant 918 in the subsequent competitive bidding process. The prospective participant 918 being associated with the market simulation service 904. The request including auction parameters and simulation parameters. The auction parameters identifying the subsequent competitive bidding process and defining certain descriptive characteristics associated with the subsequent competitive bidding process. The simulation parameters identifying the predictive information desired by the prospective participant 918 and defining certain simulation settings for deriving the predictive information.

The historical data communication module 908 is configured to obtain historical marketplace data 920 from a data storage device 922. The historical marketplace data 920 associated with the existing marketplace and the plurality of like competitive bidding processes. The statistics processing module 910 in operative communication with participant communication module 906 and historical data communication module 908 and configured to process the historical marketplace data 920 using a statistical sampling algorithm 924 and a resampling technique 926 based at least in part on the auction parameters to determine a distribution function for the like competitive bidding processes. The simulation processing module 912 in operative communication with the participant communication module 906 and statistics processing module 910 for simulating the subsequent competitive bidding process using an evolutionary algorithm 928 based at least in part on the simulation parameters and the distribution function to derive the predictive information desired by the prospective participant 918.

The simulation server 902 may comprise one or more server devices and may also include one or more additional computer devices or work stations and various computer peripheral devices in any suitable combination. The devices forming the simulation server 902 may be co-located or distributed at multiple locations. The devices forming the simulation server 902 may communicate via any suitable communication technique using serial, parallel, or network ports via wired or wireless connections.

The user device 914 may comprise any suitable type of computer platform configured to communicate with the simulation server 902 via the communication network 916, including a desktop computer, a laptop computer, a handheld computer, a mobile device, or a wireless device. The prospective participant 918 may use different user devices 914 to communicate with the simulation server 902 at different times.

The communication network 916 may comprise any suitable type of network, including a telephone network, a wireless network, a local area network, a wide area network, a metropolitan area network, a cable television network, a satellite television network, or a satellite communication network in any combination.

The data storage device 922 may comprise any suitable type of storage device, including a one or more servers, one or more hard disk drives, non-volatile memory, or a portable storage medium in any suitable combination. The devices forming the data storage device 922 may be co-located or distributed at multiple locations. The data storage device 922 may be co-located with the simulation server 902 or staged at a remote location. The devices forming the data storage device 922 may in operative communication with the simulation server 902 via any suitable communication technique using serial, parallel, or network ports via wired or wireless connections.

In another embodiment of the simulation server 902, the participant communication module 906 is also configured to make the derived predictive information available to the user device 914 via the communication network 916. In yet another embodiment of the simulation server 902, the participant communication module 906 sends the derived predictive information to the user device 914 via the communication network 916.

In still another embodiment of the simulation server 902, the subsequent competitive bidding process is provided via an auction server 930 associated with a market auction service 932. In a further embodiment of the simulation server 902, the auction server 930 is in operative communication with the data storage device 922 to provide historical marketplace data 920 to the data storage device 922 for use in conjunction with the market simulation service 904. In another further embodiment of the simulation server 902, the existing marketplace comprises the market auction service 932 and market simulation service 904.

The auction server 930 may comprise one or more server devices and may also include one or more additional computer devices or work stations and various computer peripheral devices in any suitable combination. The devices forming the auction server 930 may be co-located or distributed at multiple locations. The devices forming the auction server 930 may communicate via any suitable communication technique using serial, parallel, or network ports via wired or wireless connections. The data storage device 922 may be co-located with the auction server 930 or staged at a remote location. The devices forming the data storage device 922 may in operative communication with the auction server 930 via any suitable communication technique using serial, parallel, or network ports via wired or wireless connections.

The market auction service 932 and market simulation service 904 may be operated by the same service providers or by different service providers. If they are operated by the same service providers, the market auction service 932 and market simulation service 904 may be co-located or staged at different locations. In other embodiments, the market simulation service 904 may be associated with multiple market auction services 932 operated by different service providers.

In still yet another embodiment of the simulation server 902, the resampling technique 926 comprises a bootstrapping technique. In a further embodiment of the simulation server 902, the bootstrapping technique comprises a random sampling with replacement algorithm. In another further embodiment of the simulation server 902, the bootstrapping technique comprises a Monte Carlo algorithm.

In another embodiment of the simulation server 902, the evolutionary algorithm 928 comprises a reproduction mechanism, a mutation mechanism, a recombination mechanism, and a selection mechanism. In yet another embodiment of the simulation server 902, the evolutionary algorithm 928 comprises a genetic algorithm.

In still another embodiment of the simulation server 902, the subsequent competitive bidding process comprises an RFP with a bid to provide a specific product or service released by a prospective buyer of the specific product or service so that prospective providers can submit competitive bids in conjunction with the competitive bidding process. In a further embodiment of the simulation server 902, the prospective participant 918 in the subsequent competitive bidding process comprises the prospective buyer of the specific product or service that released the RFP. In an even further embodiment, the predictive information comprises at least one of a time parameter value representing when to end the subsequent competitive bidding process and a bid parameter value representing when to end the subsequent competitive bidding process. In another further embodiment of the simulation server 902, the prospective participant 918 in the subsequent competitive bidding process comprises a first prospective provider that is considering submitting a competitive bid for providing the specific product or service in conjunction with the competitive bidding process. In an even further embodiment, the predictive information comprises at least one of a bid parameter value representing how much to bid for providing the specific product or service, a provider team parameter value representing how to structure a team of providers to bid on providing the specific product or service, a time parameter value representing when to submit the competitive bid during the subsequent competitive bidding process, and an outsource parameter value representing how many levels to outsource in conjunction with bidding on providing the specific product or service.

In still yet another embodiment of the simulation server 902, the subsequent competitive bidding process comprises an offer for sale of a specific product or service released by a prospective provider of the specific product or service so that prospective buyers can submit competitive bids in conjunction with the competitive bidding process. In a further embodiment of the simulation server 902, the prospective participant 918 in the subsequent competitive bidding process comprises the prospective provider that offered the specific product or service for sale. In an even further embodiment, the predictive information comprises at least one of a time parameter value representing when to end the subsequent competitive bidding process and a bid parameter value representing when to end the subsequent competitive bidding process. In another further embodiment of the simulation server 902, the prospective participant 918 in the subsequent competitive bidding process comprises a first prospective buyer that is considering submitting a competitive bid to buy the specific product or service in conjunction with the competitive bidding process. In an even further embodiment, the predictive information comprises at least one of a bid parameter value representing how much to bid for buying the specific product or service and a time parameter value representing when to submit the competitive bid during the subsequent competitive bidding process.

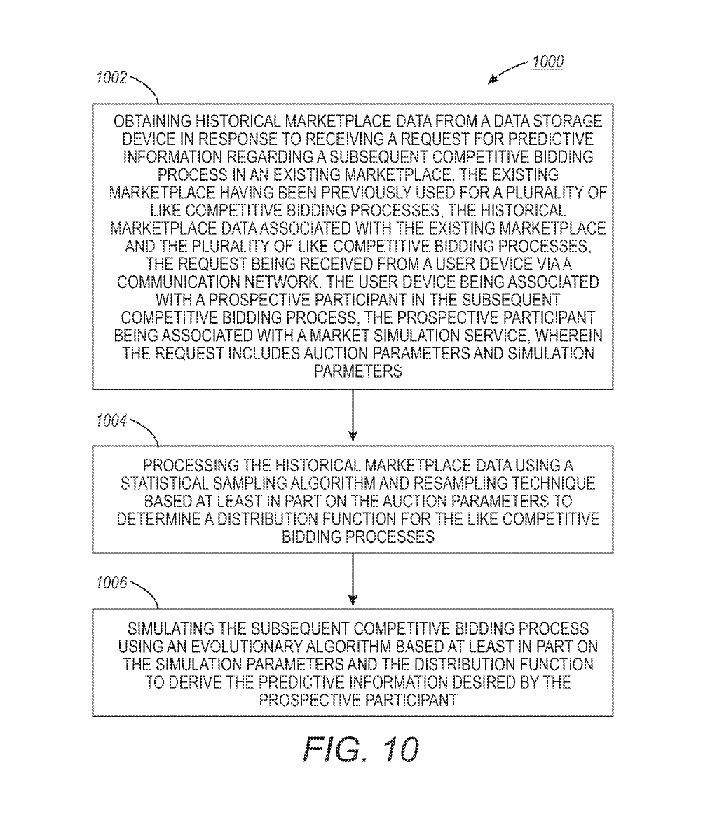

With reference to FIG. 10, another exemplary embodiment of a process 1000 for providing a market simulation service is performed by a computer-controlled device executing program instructions stored on a non-transitory computer-readable medium. The process 1000 begins at 1002 where historical marketplace data is obtained from a data storage device in response to receiving a request for predictive information regarding a subsequent competitive bidding process in an existing marketplace. The existing marketplace having been previously used for a plurality of like competitive bidding processes. The historical marketplace data associated with the existing marketplace and the plurality of like competitive bidding processes. The request being received from a user device via a communication network. The user device being associated with a prospective participant in the subsequent competitive bidding process. The prospective participant being associated with a market simulation service. The request including auction parameters and simulation parameters. The auction parameters identifying the subsequent competitive bidding process and defining certain descriptive characteristics associated with the subsequent competitive bidding process. The simulation parameters identifying the predictive information desired by the prospective participant and defining certain simulation settings for deriving the predictive information.

At 1004, the historical marketplace data is processed using a statistical sampling algorithm and a resampling technique based at least in part on the auction parameters to determine a distribution function for the like competitive bidding processes. Next, the subsequent competitive bidding process is simulated using an evolutionary algorithm based at least in part on the simulation parameters and the distribution function to derive the predictive information desired by the prospective participant (1006).

In another embodiment, the process 1000 also includes making the derived predictive information available to the user device via the communication network. In yet another embodiment, the process 1000 also includes sending the derived predictive information to the user device via the communication network. In still another embodiment of the process 1000, the resampling technique comprises a bootstrapping technique. In still yet another embodiment of the process 1000, the evolutionary algorithm comprises a genetic algorithm.

In various embodiments, the program instructions stored in the non-transitory computer-readable memory, when executed by the computer, may cause the computer-controlled device to perform various combinations of functions associated with the various embodiments of the process 800 for providing a market simulation service described above with reference to FIG. 8. In other words, the various embodiments of the process 800 described above may also be implemented by corresponding embodiments of the process 1000 associated with the program instructions stored in the non-transitory computer-readable memory.

Likewise, in various embodiments, the program instructions stored in the non-transitory computer-readable memory, when executed by the computer, may cause the computer-controlled device to perform various combinations of functions associated with the various embodiments of the simulation server 902 for providing a market simulation service described above with reference to FIG. 9. In other words, the functions associated with the various embodiments of the simulation server 902 described above may also be implemented by corresponding embodiments of the process 1000 associated with the program instructions stored in the non-transitory computer-readable memory.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method of providing a market simulation service, comprising:
a) receiving a request for predictive information regarding a subsequent competitive bidding process in an existing marketplace, the existing marketplace having been previously used for a plurality of like competitive bidding processes, the request being received from a user device via a communication network at a simulation server, the user device being associated with a prospective participant in the subsequent competitive bidding process, the simulation server being associated with a market simulation service, the prospective participant being associated with the market simulation service, wherein the request includes auction parameters and simulation parameters, the auction parameters identifying the subsequent competitive bidding process and defining certain descriptive characteristics associated with the subsequent competitive bidding process, the simulation parameters identifying the predictive information desired by the prospective participant and defining certain simulation settings for deriving the predictive information;
b) obtaining historical marketplace data from a data storage device, the historical marketplace data associated with the existing marketplace and the plurality of like competitive bidding processes;
c) processing the historical marketplace data using a statistical sampling algorithm and a resampling technique based at least in part on the auction parameters to determine a distribution function for the like competitive bidding processes; and
d) simulating the subsequent competitive bidding process using an evolutionary algorithm based at least in part on the simulation parameters and the distribution function to derive the predictive information desired by the prospective participant.

2. (canceled)

3. (canceled)

4. (canceled)

5. The method of claim 1 wherein the resampling technique comprises a bootstrapping technique.

6. The method of claim 1 wherein the evolutionary algorithm comprises a genetic algorithm.

7. The method of claim 1 wherein the subsequent competitive bidding process comprises a request for proposal with a bid to provide a specific product or service released by a prospective buyer of the specific product or service so that prospective providers can submit competitive bids in conjunction with the competitive bidding process.

8. The method of claim 7 wherein the prospective participant in the subsequent competitive bidding process comprises the prospective buyer of the specific product or service that released the request for proposal.

9. The method of claim 7 wherein the prospective participant in the subsequent competitive bidding process comprises a first prospective provider that is considering submitting a competitive bid for providing the specific product or service in conjunction with the competitive bidding process.

10. The method of claim 1 wherein the subsequent competitive bidding process comprises an offer for sale of a specific product or service released by a prospective provider of the specific product or service so that prospective buyers can submit competitive bids in conjunction with the competitive bidding process.

11. The method of claim 10 wherein the prospective participant in the subsequent competitive bidding process comprises the prospective provider that offered the specific product or service for sale.

12. The method of claim 10 wherein the prospective participant in the subsequent competitive bidding process comprises a first prospective buyer that is considering submitting a competitive bid to buy the specific product or service in conjunction with the competitive bidding process.

13. An apparatus for providing a market simulation service, comprising:
a participant communication module for receiving a request for predictive information regarding a subsequent competitive bidding process in an existing marketplace, the existing marketplace having been previously used for a plurality of like competitive bidding processes, the request being received from a user device via a communication network, the user device being associated with a prospective participant in the subsequent competitive bidding process, the prospective participant being associated with the market simulation service, wherein the request includes auction parameters and simulation parameters, the auction parameters identifying the subsequent competitive bidding process and defining certain descriptive characteristics associated with the subsequent competitive bidding process, the simulation parameters identifying the predictive information desired by the prospective participant and defining certain simulation settings for deriving the predictive information;
a historical data communication module for obtaining historical marketplace data from a data storage device, the historical marketplace data associated with the existing marketplace and the plurality of like competitive bidding processes;
a statistics processing module in operative communication with participant communication module and historical data communication module for processing the historical marketplace data using a statistical sampling algorithm and a resampling technique based at least in part on the auction parameters to determine a distribution function for the like competitive bidding processes; and
a simulation processing module in operative communication with the participant communication module and statistics processing module for simulating the subsequent competitive bidding process using an evolutionary algorithm based at least in part on the simulation parameters and the distribution function to derive the predictive information desired by the prospective participant.

14. The apparatus of claim 13 wherein the participant communication module makes the derived predictive information available to the user device via the communication network.

15. The apparatus of claim 13 wherein the participant communication module sends the derived predictive information to the user device via the communication network.

16. The apparatus of claim 13 wherein the resampling technique comprises a bootstrapping technique.

17. The apparatus of claim 13 wherein the evolutionary algorithm comprises a genetic algorithm.

18. The apparatus of claim 13 wherein the subsequent competitive bidding process comprises a request for proposal with a bid to provide a specific product or service released by a prospective buyer of the specific product or service so that prospective providers can submit competitive bids in conjunction with the competitive bidding process.

19. The apparatus of claim 13 wherein the subsequent competitive bidding process comprises an offer for sale of a specific product or service released by a prospective provider of the specific product or service so that prospective buyers can submit competitive bids in conjunction with the competitive bidding process.

20. A non-transitory computer-readable medium storing program instructions that, when executed by a computer, cause a corresponding computer-controlled device to perform a method of providing a market simulation service, the method comprising:
a) obtaining historical marketplace data from a data storage device in response to receiving a request for predictive information regarding a subsequent competitive bidding process in an existing marketplace, the existing marketplace having been previously used for a plurality of like competitive bidding processes, the historical marketplace data associated with the existing marketplace and the plurality of like competitive bidding processes, the request being received from a user device via a communication network, the user device being associated with a prospective participant in the subsequent competitive bidding process, the prospective participant being associated with a market simulation service, wherein the request includes auction parameters and simulation parameters, the auction parameters identifying the subsequent competitive bidding process and defining certain descriptive characteristics associated with the subsequent competitive bidding process, the simulation parameters identifying the predictive information desired by the prospective participant and defining certain simulation settings for deriving the predictive information;
b) processing the historical marketplace data using a statistical sampling algorithm and a resampling technique based at least in part on the auction parameters to determine a distribution function for the like competitive bidding processes, wherein the resampling technique comprises a bootstrapping technique; and
c) simulating the subsequent competitive bidding process using an evolutionary algorithm based at least in part on the simulation parameters and the distribution function to derive the predictive information desired by the prospective participant wherein the evolutionary algorithm comprises a genetic algorithm.

21. The method of claim 1 wherein the predictive information comprises a suggested auction strategy for the prospective participant.

22. The method of claim 21 wherein the suggested auction strategy is optimized for the prospective participant.

23. The apparatus of claim 13 wherein the predictive information comprises a suggested auction strategy for the prospective participant.

24. The apparatus of claim 23 wherein the suggested auction strategy is optimized for the prospective participant.

25. The non-transitory computer-readable medium of claim 20 wherein the subsequent competitive bidding process comprises a request for proposal with a bid to provide a specific product or service released by a prospective buyer of the specific product or service so that prospective providers can submit competitive bids in conjunction with the competitive bidding process.

26. The non-transitory computer-readable medium of claim 20 wherein the subsequent competitive bidding process comprises an offer for sale of a specific product or service released by a prospective provider of the specific product or service so that prospective buyers can submit competitive bids in conjunction with the competitive bidding process.

27. The non-transitory computer-readable medium of claim 20 wherein the predictive information comprises a suggested auction strategy for the prospective participant.

28. The non-transitory computer-readable medium of claim 27 wherein the suggested auction strategy is optimized for the prospective participant.
